(19) United States
(12) Patent Application Publication
(10) Pub. No.: US 2018/0032986 A1
(43) Pub. Date: Feb. 1, 2018

(54) CHECKOUT SYSTEM FOR MANAGING SETTLEMENT PROCESS INTERRUPTION AND CONTROL METHOD THEREOF

(71) Applicant: TOSHIBA TEC KABUSHIKI KAISHA, Tokyo (JP)

(72) Inventors: Daisuke MIYAGI, Mishima Shizuoka (JP); Nobuyuki TAKAHASHI, Tagata Shizuoka (JP)

(21) Appl. No.: 15/650,163

(22) Filed: Jul. 14, 2017

(30) Foreign Application Priority Data
Aug. 1, 2016 (JP) 2016-151052

(51) Int. Cl. G06Q 20/20; G06K 9/00; G07G 1/14

(52) U.S. Cl. CPC G06Q 20/202; G06Q 20/208; G07G 1/145; G06K 9/00221

(57) ABSTRACT

A checkout system according to an embodiment includes a settlement device, a management terminal, and a camera. The settlement device starts a settlement processing based on generated settlement information, and then determines that the settlement processing is interrupted. In response to the determination that the settlement processing is interrupted, the settlement device receives image data from the camera and generates a calling screen indicating that a manager is called. Based on the received image data, the settlement device determines whether the manager is positioned in a predetermined checkout area proximate to the settlement device. When the manager is determined to be positioned in the predetermined checkout area, the settlement device stops displaying the calling screen and resumes the settlement processing.

### CROSS-REFERENCE TO RELATED APPLICATION

This application is based upon and claims the benefit of priority from Japanese Patent Application No. 2016-151052, filed Aug. 1, 2016, the entire contents of which are incorporated herein by reference.

### FIELD

Embodiments described herein relate generally to a checkout system for managing settlement process interruption and a control method thereof.

### BACKGROUND

A settlement device in self-service type checkout apparatus or a semi-self-service type checkout system performs a settlement process according to an operation performed by a customer.

Such a settlement device may have a function of calling a salesperson in order to perform a process which cannot be performed by a customer, such as issuing of a receipt. As an example, if a customer operates a button for calling a salesperson, the settlement process is interrupted, and a manager at a service area, for example, is notified. The notified manager goes to a settlement device and deals with the process interruption.

In a settlement device operated in the above-described way, the manager is required to perform an operation for canceling the process interruption.

Thus, it is desirable to reduce the burden on the manager due to cancellation of process interruption.

### DESCRIPTION OF THE DRAWINGS

FIG. 1 is a perspective view of a checkout system according to one embodiment.

FIG. 2 is a block diagram illustrating example configurations of a settlement device and a POS server.

FIG. 3 is a flowchart illustrating a position detection process performed by the POS server.

FIG. 4 is a flowchart illustrating a control process for manager calling performed by the settlement device.

FIG. 5 is a flowchart illustrating a control process for manager calling performed by the POS server.

### DETAILED DESCRIPTION

Embodiments provide a checkout system for managing settlement process interruption and a control method thereof, capable of reducing a burden on a manager due to cancellation of process interruption.

A checkout system according to an embodiment includes a settlement device, a management terminal, and a camera. The settlement device starts a settlement processing based on generated settlement information, and then determines that the settlement processing is interrupted. In response to the determination that the settlement processing is interrupted, the settlement device receives image data from the camera and generates a calling screen indicating that a manager is called. Based on the received image data, the settlement device determines whether the manager is positioned in a predetermined checkout area proximate to the settlement device. When the manager is determined to be positioned in the predetermined checkout area, the settlement device stops displaying the calling screen and resumes the settlement processing.

Hereinafter, a description will be made of an example of an embodiment with reference to the drawings.

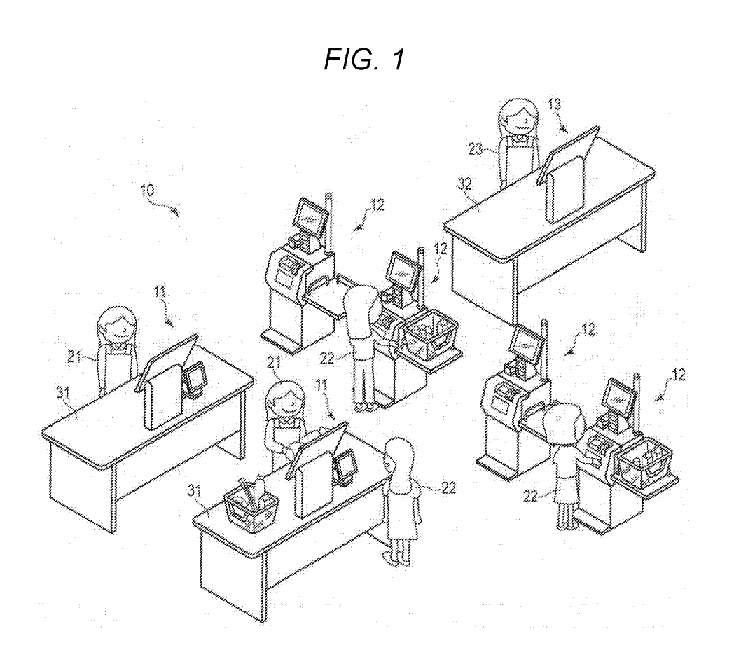

FIG. 1 is a perspective view illustrating a checkout system 10 according to the present embodiment.

The checkout system 10 includes at least one commodity registration device 11, at least one settlement device 12, and a single management terminal 13. FIG. 1 illustrates two commodity registration devices 11 and four settlement devices 12. The checkout system 10 may include any number of commodity registration devices 11 and settlement devices 12, and any ratio between the number of commodity registration devices 11 and the number of settlement devices 12 may be used. The commodity registration devices 11, the settlement devices 12, and the management terminal 13 are provided in a checkout area of a store such as a supermarket.

An employee 21 of the store who performs a function as a so-called checker is an operator of the commodity registration device 11. A shopper 22 who is settling the price of a commodity sold at the store is an operator of the settlement device 12. However, a partial operation on the commodity registration device 11 may be performed by the shopper 22. The settlement device 12 may be operated by an employee. An employee 23 of the store who performs a function as a manager is an operator of the management terminal 13.

In FIG. 1, each commodity registration device 11 is attached to a work table 31. The work tables 31 are arranged to form passages for the shopper 22. The commodity registration device 11 performs purchase registration, which is a process of registering a commodity carried by a shopper for purchasing. As hardware of the commodity registration device 11, for example, an existing POS terminal may be used.

The settlement device 12 receives settlement information from the commodity registration device 11, and performs a settlement process based on the settlement information.

The management terminal 13 performs various processes in order to monitor operation situations of each of the settlement devices 12. The management terminal 13 performs processes for various services such as a commodity return process. The management terminal 13 is attached to a service counter 32 in FIG. 1. The service counter 32 is positioned in a service area adjacent to the checkout area. The employee 23 is positioned as illustrated in FIG. 1 in the vicinity of the service counter 32. The service area is preferably defined as a space through which the shopper 22 does not pass. Access of shoppers to the service area is more preferably restricted. However, the employee 23 may leave the service area in order to deal with a shopper. A plurality of employees 23 may be positioned in the service area.

As hardware of the management terminal 13, for example, an existing general purpose computer or tablet terminal may be used. The management terminal 13 may be provided with a device used as basic hardware, and may be a computer including a CPU, a ROM, RAM, and an auxiliary storage unit configured to perform appropriate control processes so as to realize various functions.

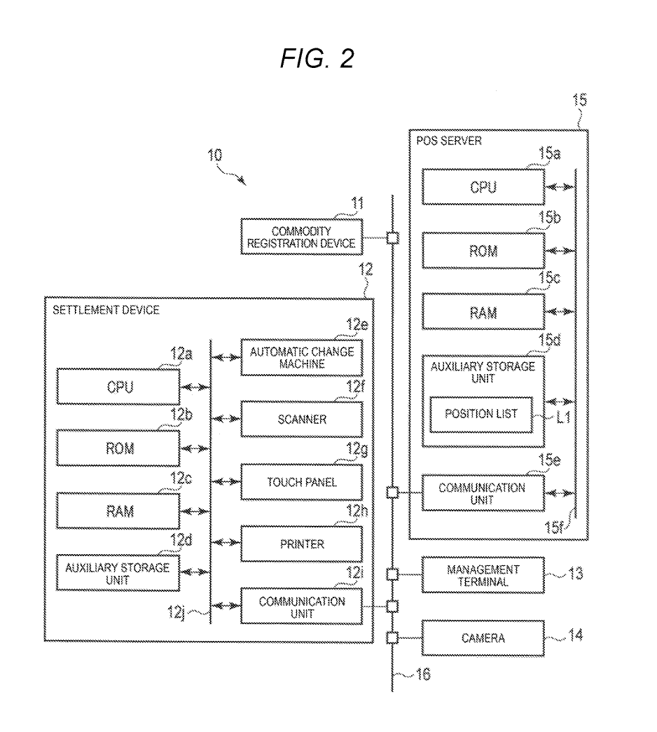

FIG. 2 is a block diagram illustrating an example configuration of the checkout system 10 including the settlement device 12 and a POS server 15.

The checkout system 10 includes the commodity registration device 11, the settlement device 12, and the management terminal 13 as illustrated in FIG. 1. The checkout system 10 also includes a camera 14 and the POS server 15.

The camera 14 is provided on, for example, a ceiling of the checkout corner, and provides imaging from a bird's eye perspective of the entire checkout area. The camera 14 repeatedly performs image generation at a predetermined time interval, and repeatedly outputs the generated image data. The camera 14 communications via a local area network (LAN) 16. The camera 14 sends the generated image data to the POS server 15 via the LAN 16. As the camera 14, an existing network camera or the like may be used. The camera 14 obtains an image corresponding to an imaging region including at least the settlement device 12 and the service area of the employee. As the camera 14, a security camera or the like may be used.

The POS server 15 may be a so-called store server provided in the store, or a so-called headquarter server provided in a headquarter performing overall management of a plurality of stores. The POS server 15 collects sales data. The POS server 15 manages data used for the commodity registration device 11 and the settlement device 12. In other words, the POS server 15 has the same function as that of an existing POS server. The POS server 15 functions as a control device controlling the settlement device 12.

The commodity registration device 11, the settlement device 12, the management terminal 13, the camera 14, and the POS server 15 are all connected via the LAN 16. Instead of the LAN 16, other communication networks such as the Internet may be used. Thus, the commodity registration device 11, the settlement device 12, and the management terminal 13 can perform communication with the POS server 15 via the LAN 16. The POS server 15 can perform communication with the camera 14 via the LAN 16.

The settlement device 12 includes a central processing unit (CPU) 12a, a read only memory (ROM) 12b, a random access memory (RAM) 12c, an auxiliary storage unit 12d, an automatic change machine 12e, a scanner 12f, a touch panel 12g, a printer 12h, a communication unit 12i, and a bus 12j.

The CPU 12a, the ROM 12b, the RAM 12c, and the auxiliary storage unit 12d are connected to each other via the bus 12j, so as to form a computer.

The CPU 12a corresponds to a main processor of the computer. The CPU 12a controls the respective elements so as to realize various functions of the settlement device 12 on the basis of an operating system, middleware, and application programs stored in the ROM 12b and the RAM 12c.

The ROM 12b corresponds to a main storage device of the computer. The ROM 12b stores the operating system. The ROM 12b may store the middleware or the application programs. The ROM 12b may store data which is referred to when the CPU 12a performs various processes.

The RAM 12c corresponds to a working storage device of the computer. The RAM 12c stores data which is ref erred to when the CPU 12a performs various processes. The RAM 12c is also used as a so-called work area which stores data temporarily used when the CPU 12a performs various processes.

The auxiliary storage unit 12d corresponds to an auxiliary storage device of the computer. The auxiliary storage unit 12d stores data used when the CPU 12a performs various processes, or data generated through processes in the CPU 12a.

The automatic change machine 12e receives input coins and bank notes. The automatic change machine 12e discharges coins and bank notes as change.

The scanner 12f reads a barcode attached to a commodity so as to obtain a commodity code of the commodity. As the scanner 12f, various well-known scanners may be used.

The touch panel 12g includes a display device and a touch sensor. As the touch panel 12g, a well-known device may be used.

The printer 12h prints various character strings or images on a receipt sheet, so as to issue a receipt.

The communication unit 12i is a communication interface that performs communication via the LAN 16.

The bus 12j transmits data between the constituent elements of the settlement device 12.

As hardware of the settlement device 12, for example, an existing self-service checkout POS terminal or a semi-self-service settlement device may be used.

The POS server 15 includes a CPU 15a, a ROM 15b, a RAM 15c, an auxiliary storage unit 15d, a communication unit 15e, and a bus 15f.

The CPU 15a, the ROM 15b, the RAM 15c, and the auxiliary storage unit 15d are connected to each other via the bus 15f, so as to form a computer. The computer controls the respective elements so as to realize various operations as the POS server 15, similar to the computer provided in the commodity registration device 11. A part of a storage region of the auxiliary storage unit 15d is used to store a position list L1 which will be described later.

The communication unit 15e performs communication via the LAN 16.

The bus 15f transmits data between the constituent elements of the POS server 15.

As hardware of the POS server 15, for example, an existing general purpose server device may be used.

The application programs stored in the ROMs 12b and 15b or the auxiliary storage units 12d and 15d include a control program for performing a control process which will be described later. The settlement device 12 and the POS server 15 are provided in a state in which the control program is generally stored in the ROMs 12b and 15b or the auxiliary storage units 12d and 15d. However, the settlement device 12 and the POS server 15 may also be provided in a state in which the control program is not stored in the ROMs 12b and 15b or the auxiliary storage units 12d and 15d. In such instances, the control program may also be provided on a removable recording medium, or through communication using a network. In this case, for example, a user or a service person performs an operation, and thus the control program is written to the ROMs 12b and 15b or the auxiliary storage units 12d and 15d. As the removable recording medium, for example, a magnetic disk, a magneto-optical disc, an optical disc, or a semiconductor memory may be used.

Next, an operation of the checkout system 10 configured as described above will be described. The process described below is only an example, and various processes causing the same result to be obtained may be used as appropriate.

When the POS server 15 is activated, the CPU 15a clears the position list L1. Thereafter, if the POS server 15 is brought into a normal operation state, the CPU 15a starts a position detection process based on the control program stored in the ROM 15b or the auxiliary storage unit 15d every predetermined start timing. A start timing of the position detection process is expected to be at a predetermined time interval, but, for example, a designer of the control program may set any timing.

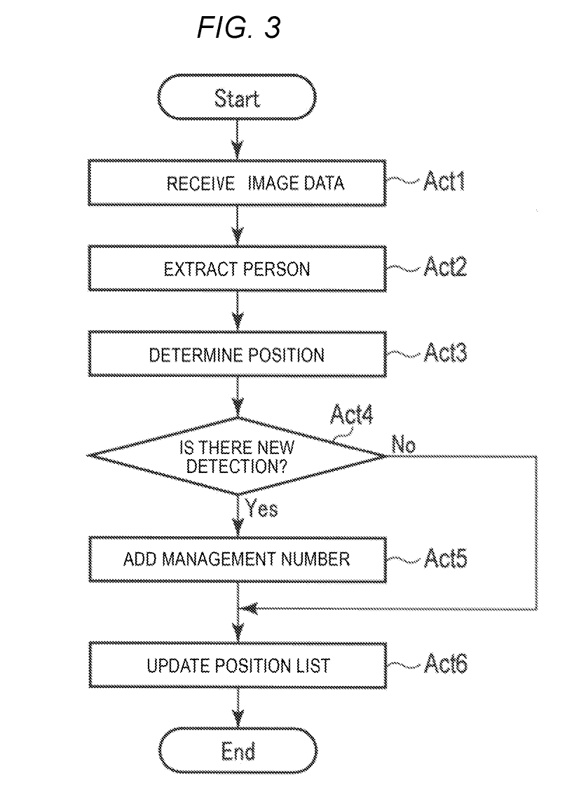

FIG. 3 is a flowchart illustrating the position detection process performed by the CPU 15a.

In Act 1, the CPU 15a receives image data output from the camera 14.

In Act 2, the CPU 15a extracts a person included in an image indicated by the image data incorporated in Act 1. A well-known technique may be applied when implementing the process in Act 2.

In Act 3, the CPU 15a determines a position of the person extracted in Act 2. In a case where more than one person are extracted in Act 2, the CPU 15a determines a position of each person. Therefore, the CPU 15a performs the position detection process based on the control program, and thus the computer having the CPU 15a as a main processor functions as a determination unit determining a position of a person included in an image on the basis of the image captured by the camera.

In Act 4, the CPU 15a checks whether or not there is a newly detected person among the persons extracted in Act 2. Specifically, the CPU 15a checks whether or not each of the persons extracted in Act 2 is registered in the position list L1. The position list L1 includes position information indicating the latest determined position and tracking information for a person stored in correlation with a management number for each extracted person. The tracking information is information which is referred to in order to determine whether or not the person extracted in Act 2 is the same as a person already registered in the position list L1. Any information may be used as the tracking information, and may be defined by, for example, a designer of the control program of the CPU 15a. It is expected that, as the tracking information, for example, information indicating features such as clothing reflected in the image, or position information regarding a position detected in the past is used.

If a new person (i.e., other than a person already registered in position list L1) is extracted, the CPU 15a determines Yes, and proceeds to Act 5. Any well-known technique of recognizing whether or not each person reflected in images which are repeatedly captured in the same imaging region is the same person may be applied to the process in Act 4.

In Act 5, the CPU 15a adds a management number, different from management numbers already written in the position list L1, to the position list L1 in correspondence with the newly extracted person. Then, the CPU 15a proceeds to Act 6. If all of the persons extracted in Act 2 are persons with the corresponding management numbers already written in the position list L1, the CPU 15a determines No in Act 4, and skips Act 5 and proceeds to Act 6.

In Act 6, the CPU 15a updates the position list L1 so that position information indicating the determined position of each person extracted in Act 2 is stored in correlation with the management number added to the person. If the updating of the position list L1 is completed, the CPU 15a finishes the position detection process. If a management number in the position list L1 does not correspond to any person extracted in Act 2, the CPU 15a deletes the management number and information correlated with the management number from the position list L1.

Thus, the POS server 15 manages a position of each person present in the imaging region of the camera 14 in the position list L1 in correlation with a management number added to the person. Therefore, the POS server 15 tracks a person present in the imaging region of the camera 14.

The commodity registration device 11 performs purchase registration according to a well-known process. Settlement information generated by the commodity registration device 11 due to the purchase registration is transmitted to the settlement device 12. A process performed in a settlement device or the like of an existing semi-self-service type checkout system may be applied to a method of determining the settlement device 12 which is a transmission destination of the settlement information and a method of transmitting the settlement information without being changed. Various proposals are made on the determination method and the transmission method, and any one thereof may be applied.

If the commodity registration device 11 notifies the settlement device 12 of settlement information, the settlement device 12 performs a settlement process based on the settlement information. For example, a process performed in a settlement device or the like of an existing semi-self-service type checkout system may be applied to the settlement process without being changed. Therefore, the CPU 12a performs a control process based on the control program, and thus the computer having the CPU 12a as a main processor functions as a settlement unit.

If an amount of money used as a settlement amount is shown in the settlement information, the CPU 12a performs the settlement process as a process for settling the amount of money. However, if an amount of money used as a settlement amount is not shown in the settlement information, the CPU 12a performs a process of calculating a settlement amount. If the CPU 12a calculates a settlement amount in the above-described way, the settlement device 12 is also referred to as an accounting device.

Meanwhile, the CPU 12a performs a control process related to manager calling on the basis of the control program stored in the ROM 12b or the auxiliary storage unit 12d separately from a process related to the settlement process.

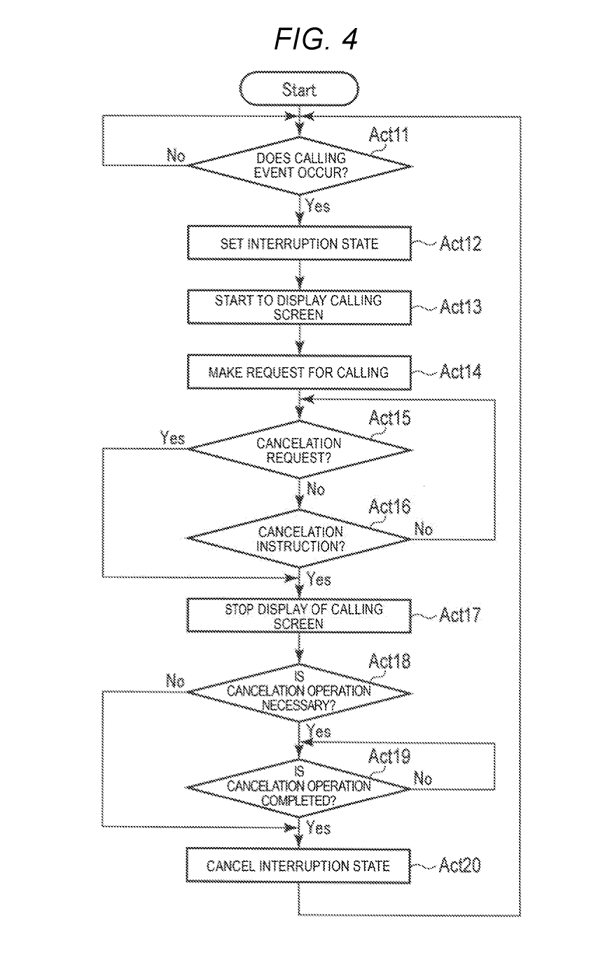

FIG. 4 is a flowchart illustrating a control process related to manager calling performed by the CPU 12a.

In Act 11, the CPU 12a checks whether or not an event (hereinafter, referred to as a calling event) causing a manager to be called occurs. For example, a designer of the settlement device 12 may define any particular event as a calling event. As an example of the calling event, a salesperson calling button displayed on the touch panel 12g may be subject to a touch operation. As another example of the calling event, a state requiring maintenance may occur such as a case where coins for change are required to be supplemented. If a calling event occurs, the CPU 12a determines Yes, and proceeds to Act 12.

In Act 12, if other processes such as a settlement process are in progress, the CPU 12a interrupts the process.

In Act 13, the CPU 12a generates a calling screen on the touch panel 12g. The calling screen is a screen for providing notice that a salesperson is being called.

In Act 14, the CPU 12a requests the POS server 15 to call a manager. Specifically, the CPU 12a sends, for example, predefined request information (hereinafter, referred to as calling request information) for calling the manager from the communication unit 12i to the POS server 15 via the LAN 16. If the calling request information is transmitted to the POS server 15 via the LAN 16, the calling request information is received by the communication unit 15e. The CPU 12a causes an identification code for identifying the settlement device 12 and an identification code for identifying the occurred calling event to be included in the calling request information.

Meanwhile, in the POS server 15, the CPU 15a performs a control process related to manager calling on the basis of the control program stored in the ROM 15b or the auxiliary storage unit 15d.

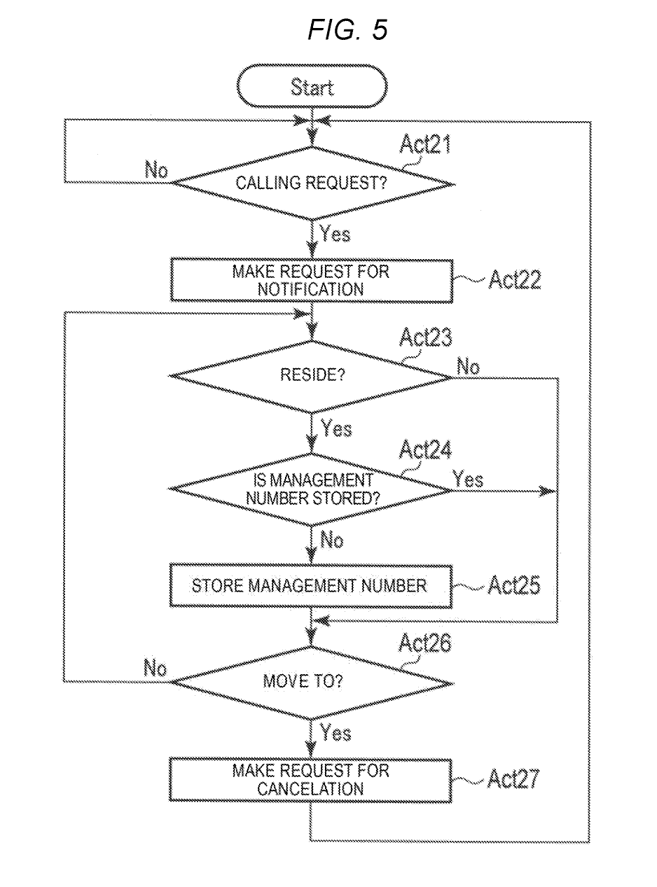

FIG. 5 is a flowchart illustrating a control process related to manager calling performed by the CPU 15a.

In Act 21, the CPU 15a checks whether or not calling request information is received. If calling request information is not received, the CPU 15a repeatedly executes Act 21. Thus, in Act 21, the CPU 15a waits for a request for manager calling. If the calling request information is received by the communication unit 15e, the CPU 15a determines Yes, and proceeds to Act 22.

In Act 22, the CPU 15a sends a request to the management terminal 13 to perform a notification. Specifically, the CPU 15a sends, for example, predefined request information for a notification (hereinafter, referred to as notification request information) from the communication unit 15e to the management terminal 13 via the LAN 16. If the notification request information is transmitted to the management terminal 13 via the LAN 16, the notification request information is received by the management terminal 13. The CPU 15a causes the two identification codes included in the calling request information as described above to be included in the notification request information. The request for a notification is an example of a notification process for performing a notification according to a notification operation which will be described later. Therefore, the CPU 15a performs the control process based on the control program, and thus the computer having the CPU 15a as a main processor functions as a notification unit.

If the notification request information is received, the management terminal 13 starts a notification operation for notifying the employee 23 that an action with respect to the settlement device 12 is necessary. The notification operation is displaying a notification screen on a display device indicating that an action with respect to in the settlement device 12 is necessary. The management terminal 13 notifies the employee 23 of the settlement device 12 identified by the identification code included in the notification request information and the calling event according to the notification operation. Thus, the management terminal 13 functions as a notification device performing a notification operation for notifying the employee 23 in the service area of the occurrence of a calling event.

The CPU 15a of the POS server 15 makes the request for a notification in Act 22, and then proceeds to Act 23.

In Act 23, the CPU 15a checks whether or not the employee 23 is in the service area. Specifically, the CPU 15a checks whether or not position information indicating a position in the service area is included in the position list. If the position information indicating the position in the residence space is included in the position list, the CPU 15a determines Yes, and proceeds to Act 24. In the above-described position detection process, whether or not a person extracted from the image data is the employee 23 is not checked. However, generally, the shopper 22 does not enter the service area, whereas the employee 23 normally is in the service area, and thus there is a high probability that a person present in the service area may be the employee 23. Therefore, in the present embodiment, if a person is present in the service area, the employee 23 is regarded as being present in the service area.

In Act 24, the CPU 15a checks whether or not all management numbers correlated with position information indicating positions in the service area in the position list L1 are already stored in the RAM 15c or the auxiliary storage unit 15d. If the management number is not stored yet, the CPU 15a determines No, and proceeds to Act 25.

In Act 25, the CPU 15a stores, in the RAM 15c or the auxiliary storage unit 15d, a management number in correlation with correlated with the position information that is not already stored in the RAM 15c or the auxiliary storage unit 15d. Thus, a management number of the employee 23 positioned in the service area when the management terminal 13 performs a notification operation is stored in the RAM 15c or the auxiliary storage unit 15d. Consequently, the computer having the CPU 15a as a main processor functions as a management unit which manages position information of a person whose determined position, when the notification is performed, is located in the service area.

Thereafter, the CPU 15a proceeds to Act 26. If the position information indicating a position in the service area is not included in the position list, and thus No is determined in Act 23, the CPU 15a skips Act 24 and Act 25, and proceeds to Act 26. If all of the management numbers correlated with position information indicating positions in the service area in the position list are already stored in the RAM 15c or the auxiliary storage unit 15d, the CPU 15a determines Yes in Act 24, and skips Act 25 to proceed to Act 26.

In Act 26, the CPU 15a checks whether or not the employee 23 moves to the settlement device 12 which made the request for the manager calling. Specifically, the CPU 15a checks whether or not any one of pieces of the position information correlated with the management numbers in the position list stored in the RAM 15c or the auxiliary storage unit 15d indicates a position of the settlement device 12 which made a request for the manager calling. The position during management is a position where the employee 23 should stand in order to address a calling event, and is defined by, for example, a worker installing the checkout system 10. If there is no matching, the CPU 15a determines No, and returns to Act 23. Thus, in Act 23 to Act 26, the CPU 15a waits for the employee 23 that is in the service area when the management terminal 13 is notified to move to the settlement device 12 which made a request for the manager calling. If the employee 23 has moved to the settlement device 12, the CPU 15a determines Yes in Act 26, and proceeds to Act 27.

In Act 27, the CPU 15a requests the settlement device 12 which made a request for the manager calling to cancel the calling state. Specifically, the CPU 15a sends, for example, predefined request information (hereinafter, referred to as cancellation request information) for cancellation from the communication unit 15e to the settlement device 12 via the LAN 16. Thereafter, the CPU 15a returns to a waiting state in Act 21. If the cancellation request information is transmitted to the settlement device 12 via the LAN 16, the cancellation request information is received by the communication unit 12i of the settlement device 12.

Returning now to FIG. 4, after displaying the display calling screen, the settlement device 12 (Act 13), the CPU 12a requests the POS server 15 to call the manager in Act 14 in FIG. 4, and then proceeds to Act 15.

In Act 15, the CPU 12a checks whether or not a cancellation request is made. The CPU 12a determines No if the cancellation request information is not received by the communication unit 12i as described above, and proceeds to Act 16.

In Act 16, the CPU 12a checks whether or not a cancellation instruction is given through an operation on the touch panel 12g. If a cancellation instruction is not given, the CPU 12a returns to Act 15.

Thus, in Act 15 and Act 16, the CPU 12a waits for a cancellation request or a cancellation instruction to be made or given. If the cancellation request information is received by the communication unit 12i as described above, the CPU 12a determines Yes in Act 15, and if a cancellation instruction is given, the CPU 12a determines Yes in Act 16. The CPU 12a proceeds to Act 17 in either case.

In Act 17, the CPU 12a stops displaying the calling screen on the touch panel 12g.

In Act 18, the CPU 12a checks whether or not the settlement device 12 is required to perform an operation (hereinafter, referred to as a cancellation operation) in order to cancel the calling event. For example, if coins for change are required to be supplemented, the settlement device 12 is required to perform an operation for supplementing coins. If a cancellation operation is necessary as in this example, the CPU 12a determines Yes, and proceeds to Act 19.

In Act 19, the CPU 12a checks whether or not the cancellation operation is completed. If the cancellation operation is not completed, the CPU 12a determines No, and repeatedly executes Act 19. Thus, in Act 19, the CPU 12a waits for the cancellation operation to be completed. If the cancellation operation is completed, the CPU 12a determines No, and proceeds to Act 20.

In the present embodiment, a control process related to the cancellation operation is performed according to a process or a thread which is different from that in the control process illustrated in FIG. 4, and description thereof will be omitted.

On the other hand, for example, if the employee 23 issues a receipt in which necessary items are written on a receipt sheet by handwriting, the settlement device 12 is not required to perform an operation for this. If a cancellation operation is not necessary, as in this example, the CPU 12a determines No in Act 18, skips Act 19, and proceeds to Act 20.

In Act 20, the CPU 12a cancels the interruption state set in Act 12, and resumes the interrupted process. Thereafter, the CPU 12a returns to a waiting state in Act 11.

However, the process in Act 17 performed by the CPU 12a is one of a series of processes for canceling the interruption state which is set due to the occurrence of the calling event, and is an example of a process related to addressing the calling event. Therefore, the CPU 12a performs a control process based on the control program, and thus the computer having the CPU 12a as a main processor functions as a control unit.

According to the above-described checkout system 10, the following effects are achieved.

Display of a calling screen in the settlement device 12 according to the occurrence of a calling event in the settlement device 12 is automatically ended if a person present in the service area moves to a position during management which is defined for the settlement device 12 after the management terminal 13 starts a notification. Therefore, the employee 23 is not required to perform an operation to end the display of the calling screen, and a burden on the employee 23 due to cancellation of process interruption can be reduced.

If a cancellation operation can be started without receiving an instruction from the employee 23, the CPU 12a may perform a process for starting the cancellation operation as a part of the control process illustrated in FIG. 4. In the above-described way, the employee 23 is not also required to perform an operation for starting a cancellation operation, and thus a burden on the employee 23 can be further reduced.

If a position of the employee 23 in the image is changed from the service area to a different position, the POS server 15 determines that the employee 23 moves to the settlement device 12. Therefore, a device such as a sensor for detecting that the employee 23 comes close to the settlement device 12 is not required to be provided, and thus the detection can be realized with a simple configuration.

According to the embodiment, a position detection process is performed by the POS server 15, and a result thereof can be used in common for determination of whether or not the respective employees 23 go to a plurality of settlement devices 12. Therefore, efficiency of this process can be improved as a whole of the system compared with a case where the settlement devices 12 perform each position detection process.

In the present embodiment, the following various modifications may occur.

The CPU 12a may perform a position detection process. In this case, the computer having the CPU 12a as a main processor functions as a determination unit. In this case, the CPU 12a may execute Act 23 to Act 26 in the control process illustrated in FIG. 5 instead of Act 14 to Act 16 in the control process illustrated in FIG. 4, and may proceeds to Act 17 if Yes is determined in Act 26. In this case, the computer having the CPU 12a as a main processor functions as a notification unit, a management unit, and a control unit.

A CPU of the management terminal 13 may perform at least one of the position detection process illustrated in FIG. 3 and the control process illustrated in FIG. 5. If the CPU of the management terminal 13 performs the position detection process illustrated in FIG. 3, a computer having the CPU as a main processor functions as a determination unit. If the CPU of the management terminal 13 performs the control process illustrated in FIG. 5, a computer having the CPU as a main processor functions as a notification unit, a management unit, and a control unit. However, in this case, in Act 22, the CPU of the management terminal 13 starts a notification operation instead of making a request for a notification. In other words, the CPU of the management terminal 13 performs a process for performing the notification operation as a notification process using the notification unit.

There is a case where a physical feature of the face or the like of a person located in a service area is extracted from an image captured by the camera 14 or another camera. In this case, the CPU 15a may check whether or not the person located in the service area is the employee 23 acting as a manager on the basis of the feature. In Act 25, the CPU 15a may store only a management number of the person confirmed as the employee 23. In the above-described way, for example, even if a person other than the employee 23 enters the service area, and that person then moves near the settlement device 12 in which a calling event occurs, display of a calling screen is not wrongly finished. Since there is no problem even if a person other than the employee 23 enters the service area, a degree of freedom of defining the service area can be improved. In this case, the computer having the CPU 15a as a main processor functions as a recognition unit which recognizes that a person reflected in an image is a manager.

Some or all of the functions realized by each of the CPU 12a and the CPU 15a may be realized by hardware such as a logic circuit which performs information processing which is not based on a program. Each of the functions may be realized by combining software control with the hardware such as a logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server for managing a checkout system including the server, a settlement device that performs settlement processing based on generated settlement information, a management terminal, and a camera, the server comprising:
a communication interface configured to communicate with the settlement device, the management terminal, and the camera;
a storage unit; and
a processor configured to:
receive, from the settlement device, a calling request based on the settlement processing being interrupted,
in response to the received calling request, transmit a notification request to the management terminal to perform a notification process,
receive image data from the camera,
determine, based on the received image data, whether a manager is positioned in a predetermined checkout area proximate to the settlement device, and
when the manager is determined to be positioned in the predetermined checkout area, transmit a cancellation request to the settlement device including instructions to resume the settlement processing.

2. The server according to claim 1, wherein the manager is determined to be positioned in the predetermined checkout area based on:
prior to receiving the calling request, receiving first image data from the camera and, based on the first image data, determining that a person is positioned in a predetermined service area proximate to the management terminal,
after transmitting the notification request, receiving second image data from the camera and, based on the second image data, determining that the person is not positioned in the predetermined service area.

3. The server according to claim 1, wherein the manager is determined to be positioned in the predetermined checkout area based on:
identifying a person in the image data as the manager based on features extracted from the image data compared to previously stored features corresponding to the manager.

4. The server according to claim 3, wherein the manager is determined to be positioned in the predetermined checkout area based further on:
determining, based on the image data, that the person identified as the manager is positioned in the predetermined checkout area.

5. The server according to claim 1, wherein the instructions to perform the notification process includes an identification code for identifying a cause of the settlement processing being interrupted.

6. The server according to claim 1, wherein the server is configured to communicate with a plurality of checkout devices included in the checkout system.

7. The server according to claim 1, wherein the instructions to perform the notification process includes instructions to display a notification screen that identifies the settlement device on a display of the management terminal.

8. A settlement device for use in a checkout system including the settlement device, a management terminal, and a camera, the settlement device comprising:
a communication interface configured to communicate with the management terminal and the camera;
a storage unit;
a display device; and
a processor configured to:
start a settlement processing based on generated settlement information,
determine that the settlement processing is interrupted,
in response to the determination that the settlement processing is interrupted, receive image data from the camera and generate a calling screen for display on the display device indicating that a manager is called,
determine, based on the received image data, whether the manager is positioned in a predetermined checkout area proximate to the settlement device,
when the manager is determined to be positioned in the predetermined checkout area, control the display device to stop displaying the calling screen, and
resume the settlement processing.

9. The settlement device according to claim 8, wherein the processor is further configured to:
after the manager is determined to be positioned in the predetermined checkout area, determine whether a cancellation operation is necessary to resume the settlement processing, and
if the cancellation operation is determined to be necessary, determine that the cancellation operation is complete before resuming the settlement processing.

10. The settlement device according to claim 8, wherein the manager is determined to be positioned in the predetermined checkout area based on:
prior to receiving the calling request, receiving first image data from the camera and, based on the first image data, determining that a person is positioned in a predetermined service area proximate to the management terminal,
after transmitting the notification request, receiving second image data from the camera and, based on the second image data, determining that the person is not positioned in the predetermined service area.

11. The settlement device according to claim 8, wherein the manager is determined to be positioned in the predetermined checkout area based on:
identifying a person in the image data as the manager based on features extracted from the image data compared to previously stored features corresponding to the manager.

12. The settlement device according to claim 11, wherein the manager is determined to be positioned in the predetermined checkout area based further on:
determining, based on the image data, that the person identified as the manager is positioned in the predetermined checkout area.

13. The settlement device according to claim 8, wherein the processor is further configured to:
in response to the determination that the settlement processing is interrupted, transmit a calling request including instructions to perform a notification process in the manager terminal.

14. The settlement device according to claim 13, wherein the calling request includes an identification code for identifying a cause of the settlement processing being interrupted.

15. The settlement device according to claim 13, wherein the instructions to perform the notification process includes instructions to display a notification screen that identifies the settlement device on a display of the management terminal.

16. A method of controlling a settlement device in a checkout system including the settlement device, a management terminal, and a camera, the method comprising the steps of:
starting a settlement processing based on generated settlement information;
determining that the settlement processing is interrupted;
in response to the determination that the settlement processing is interrupted, receiving image data from the camera and generating a calling screen for display on a display device indicating that a manager is called;
determining, based on the received image data, whether the manager is positioned in a predetermined checkout area proximate to the settlement device; and
when the manager is determined to be positioned in the predetermined checkout area, stop displaying the calling screen; and
resuming the settlement processing.

17. The method according to claim 16, further comprising the steps of:
after the manager is determined to be positioned in the predetermined checkout area, determining whether a cancellation operation is necessary to resume the settlement processing; and
if the cancellation operation is determined to be necessary, determining that the cancellation operation is complete before resuming the settlement processing.

18. The method according to claim 16, wherein the manager is determined to be positioned in the predetermined checkout area based on:
prior to receiving the calling request, receiving first image data from the camera and, based on the first image data, determining that a person is positioned in a predetermined service area proximate to the management terminal,
after transmitting the notification request, receiving second image data from the camera and, based on the second image data, determining that the person is not positioned in the predetermined service area.

19. The method according to claim 16, wherein the manager is determined to be positioned in the predetermined checkout area based on:
identifying a person in the image data as the manager based on features extracted from the image data compared to previously stored features corresponding to the manager.

20. The method according to claim 16, further comprising the step of:
in response to the determination that the settlement processing is interrupted, transmitting a calling request including instructions to perform a notification process in the manager terminal.
